(19) United States
(12) Patent Application Publication
(10) Pub. No.: US 2002/0173344 A1
(43) Pub. Date: Nov. 21, 2002

(54) Novel personal electronics device

(76) Inventors: Bryan T. Cupps, Capitola, CA (US); Tim J. Glass, Aptos, CA (US)

Correspondence Address: FLEHR HOHACH TEST, ALBRITTON & HERBERT LLP, Suite 3400, Four Embarcadero Center, San Francisco, CA, 94111, US

(21) Appl. No.: 09/809,963

(22) Filed: Mar. 16, 2001

(51) Int. Cl. H04B 1/38

(52) U.S. Cl. 455/566; 455/556; 455/557

(57) ABSTRACT

An Electronic device combines the features of one or more of: cellular telephone, Personal Digital Assistant (PDA), personal computer, Internet Appliance (IA), pager, cordless telephone, remote control unit (for example, for use with television, stereo, entertainment devices, and so forth) and Global Positioning System (GPS) into one common easy to use universal device and User Interface (UI). In one embodiment the device is approximately the size of a cellular telephone, and includes a large touchscreen LCD, that spans a significant portion of the length and width of the device, for example, covering an area which would normally be used for both the display and keypad on a cellular telephone. The display and UI change to look appropriate for whatever application in use. In one embodiment, the cellular telephone display and UI are selected from one of a plurality of cellular telephone displays images and UIs, so that a user familiar with one brand or model of cellular telephone can have that image and UI to utilize with the device.

### FIELD OF THE INVENTION

This invention pertains to personal electronic devices in the general category of Smart Handheld Device (including PDAs, Personal Companions, PC Companions, Smart Phones, Data-enabled Mobile Phones), PC Computers (including Portables, Laptops, Notebooks, Ultra Portables and Desktop Computers), mobile telephones, and the like.

With electronics becoming more sophisticated, a wide variety of devices have become available to provide users with a tool to help them manage their affairs and improve their ability to communicate both at work and in their personal lives. Computers are well known and have taken on a variety of flavors, including portable computers, which can be carried from place to place very conveniently. Mobile telephones have come into widespread use due to their small size and ease of use and the widespread availability of cellular services in a large portion of the industrialized world. More recently, small computer-like devices, having very limited computational capabilities, have become popular and are often referred to as “Smart Handheld Devices” or “Personal Digital Assistance” (PDAs). Such PDAs are typically small hand held devices including a battery, LCD touchscreen, a small amount of memory (typically on the order of 8 to 16 Megabytes of RAM) and a small amount of computer processing capability. Given the small battery size and the limited memory and computational power, such PDAs have typically been used for contact management, scheduling appointments, and e-mail. The common practice of a PDA user is to routinely synchronize their PDA data with their desktop PC computer. This synchronization requirement is an awkward and time consuming routine to maintain.

FIG. 1 is a block diagram depicting a typical prior art cellular telephone, including a battery, a display, a Man Machine Interface (MMI) and a cellular telephone module which includes RF Circuitry, and a Digital Signal Processor (DSP).

A current trend is to include both PDAs functions and cellular telephone functions in a single device of some sort. One such attempt is the HandSpring® Visor® Phone System, which basically takes a HandSpring PDA device, and mechanically attached thereto a separate cellular telephone device. This device is shown in block diagram in FIG. 2A in which System 100 includes PDA 101 and an attached Cellular Telephone Module 102. Such a device is somewhat cumbersome and includes two separate batteries, a first for PDA 101 and a second for Cellular Telephone Module 102. Since PDA 101 and Cellular Telephone Module 102 are connected by one or more external interfaces, the communication speeds between PDA 101 and Cellular Telephone Module 102 are rather limited. These devices are heavy, weighing approximately 10 ounces and with a bulky form-factor, in that you must “talk” into your PDA, holding the PDA with the Cellular Telephone Module attached.

Another approach is to develop a singular device, which serves as both a PDA and a cellular telephone. Such a device is shown by way of example in FIG. 2B and typically includes a Cellular Telephone Module 201 and LCD Display 202, a Processor 204, and a Battery 203. It appears that these types of devices are basically advances on cellular telephones, including additional features. Such devices include the Kyocera® pdQ® Smart Phone series of devices which combines CDMA digital wireless telephone technology with Palm®PDA capabilities. The pdQ® Smart Phone device is essentially a telephone including a pushbutton pad for making telephone calls, wherein the pushbutton pad pivots out of the way to reveal a larger LCD screen for use with PDA functions. Nokia has a similar device, the Nokia® 9110 Communicator, which appears as a basic cellular telephone including pushbutton keys, and opens up to reveal a larger LCD screen and a mini-keypad with PDA functions.

There are significant problems with PDAs, Internet Appliances (IAs) and cellular telephones; the PDA, IA and cellular telephone metaphors are dramatically different than what users understand in the PC computing world, having less powerful CPUs, less memory, restricted power consumption, smaller displays, and different and awkward input devices. There is limited screen size and the lack of a mouse or touchscreen, which requires a different UI metaphor, as compared with PCs. In some cases, there are touchscreens, but the small display sizes make the input and display of information cumbersome.

The two biggest problems with PDAs and Internet Appliances (IAs) are that they lack the full power of a PC and from a price vs. performance perspective- the limited capabilities outweigh the benefits. Many PDAs are actually “slave devices” to PCs and the IAs lack horsepower of a “full-blown” PC, such as a Pentium class PC. For this reason IAs are close enough in functionality to a PC that the price difference is not dramatic enough to warrant purchasing an IA. Similarly, PDAs are significantly less powerful than a PC such that even with the relatively large price difference, in many cases purchase of a PDA is not justified.

The largest complaint about cellular phones, PDAs and IAs is that they all operate independently of each other. Some vendors have attempted to integrate the PDA and the cellular telephone, but these devices still lack the horsepower, display and input power of a PC. Some integration occurs between PDAs and PCs, because, as mentioned earlier, PDAs are inherently “slave” devices to a PC.

### SUMMARY

Because there will always be a performance gap between the very best desktop computers, PDAs, and cellular phones, a device is required that combines and consolidates these technologies in a meaningful device and UI. This Novel Personal Electronic Device will combine the functionality of a cellular phone, PDA, PC and IA.

The present invention is based on the belief that the convenience of mobile devices should be contained in one universal device. While cell phones, personal digital assistants and laptop computers are evolving, the information contained in each is disparate, limited, difficult to view, and often needs to be synchronized with a home or office based PC in order to be useful. Mobile device users are information seekers who are becoming increasingly frustrated with devices that seem to only provide a piece of what they need. In order for users to satisfy their communication and computing requirements they must manage multiple devices and learn new operating environments that all have their own set of issues.

The present invention provides for one consummate handheld personal electronic device. Users will not need to learn a new operating system. There is no need for new, third party software development. All the applications that users run each day on their laptops or desktop computers can be utilized. This device is completely mobile, fitting into a shirt pocket, a purse or the palm of one's hand.

### BRIEF DESCRIPTION OF THE DRAWINGS

FIG. 1 is a blocked diagram of a typical prior art cellular telephone;

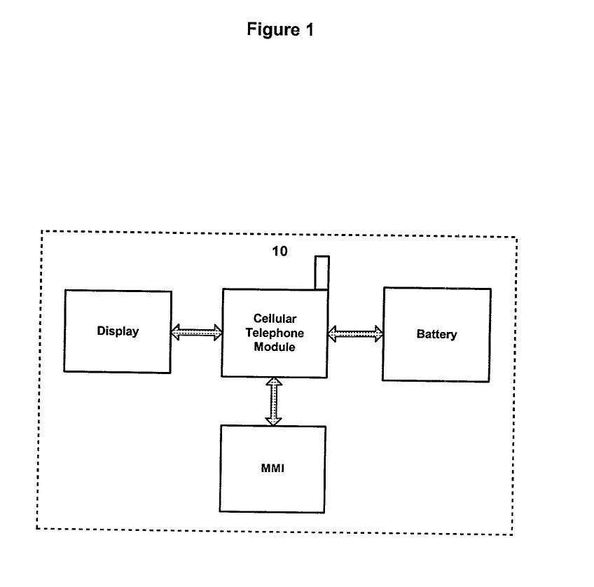

FIG. 2A is a block diagram of a prior art PDA with a physically attached Cellular Telephone Module;

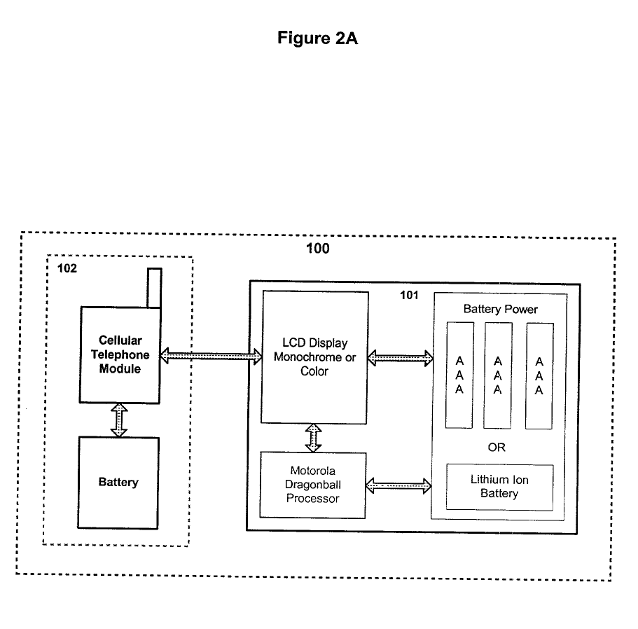

FIG. 2B is a block diagram depicting a prior art integrated Cellular Phone and PDA;

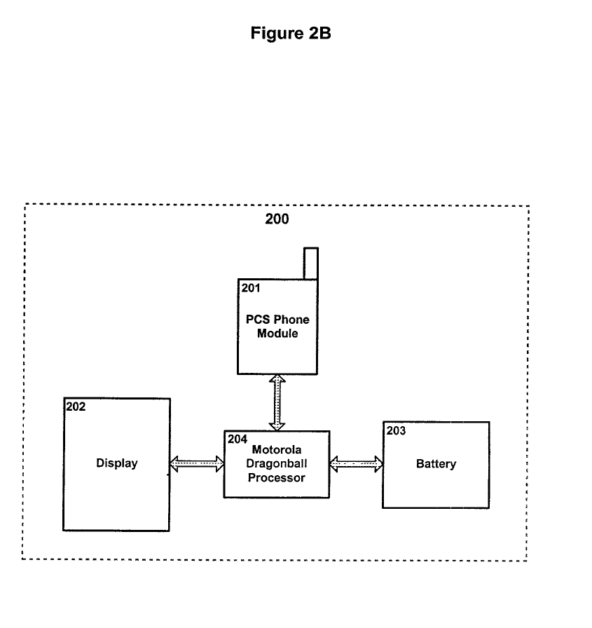

FIG. 3 is a block diagram of one embodiment of a novel personal electronics device of the present invention;

FIG. 4A depicts a more detailed diagram of one embodiment of Display Controller 308 of FIG. 3;

FIG. 4B depicts an alternative embodiment of the operation of Display 307 of FIG. 3;

FIG. 5 depicts one embodiment of the present invention, showing the physical characteristics of this embodiment;

FIG. 6 is a block diagram depicting one embodiment in which the novel personal electronics device of the present invention is used in conjunction with external computer accessories;

FIG. 7 is a block diagram depicting one embodiment in which the personal electronics device of this invention is used in connection with a conventional computer through the use of a slave unit;

FIG. 8 is a diagram depicting one embodiment of this invention which includes a personal electronics device in conjunction with a docking station;

FIG. 9 is a block diagram depicting one embodiment of a network, which includes one or more personal electronic devices of this invention; and

FIG. 10 is a block diagram depicting one embodiment of a home personal network, showing three network subnets such as Wireless, Ethernet and Phone line New Alliance (PNA), which includes one or more personal electronic devices of this invention.

### DETAILED DESCRIPTION

In accordance with the teachings of this invention a novel electronic device is taught that combines the features of one or more of: cellular telephone, Personal Digital Assistant (PDA), personal computer, Internet Appliance (IA), pager, cordless telephone, remote control unit (for example, for use with television, stereo, entertainment devices, and so forth) and Global Positioning System (GPS) into one common easy to use universal device and User Interface (UI). In one embodiment of the invention, the novel electronic device is approximately the size of a cellular telephone, and includes a large touchscreen Liquid Crystal Display (LCD), that spans a significant portion of the length and width of the device, for example, covering an area which would normally be used for both the display and keypad on a cellular telephone. As one novel feature of this invention, the display and UI change to look appropriate for whatever application in use. For example, if the user desires to use the electronic device as a cellular telephone, the device provides on the LCD screen a cellular telephone image having a full size keypad. The UI is provided such that the cellular telephone image provided on the LCD will operate when the user touches appropriate locations on the touchscreen LCD. This is interpreted by the cellular telephone application as a mouse “click” event. The same functionality can occur through the use of a jog dial by “scrolling” over the keypad numbers, and when highlighted “click” the jog dial, by depressing the dial. This is interpreted by the cellular telephone as a mouse “click” as well. By using the touchscreen, the user pushes the touchscreen buttons just as if the user were pushing a keypad on a standard cellular telephone. By speaking into the microphone and through the use of the voice activated software, the user can speak the words “Dial Phone number, (then speak the telephone number)”. In one embodiment of this invention, the cellular telephone display and UI are selected from one of a plurality of cellular telephone displays images and UIs, so that a user familiar with one brand or model of cellular telephone can have that image and UI to utilize with the device in accordance with the present invention.

By touching an appropriate area on the LCD screen, or through the use of the jog dial on the device, a user transforms the device into other useful software-driven formats, such as a PDA, T.V. remote control, and so forth.

In one embodiment, the novel electronic device of the present invention utilizes both wireless and PC Hardware. In one such embodiment, the device uses three processors, for example, a Phone Module ARM 7 Core Processor, the Intel® Embedded StrongARM® 1110 Processor, and the Intel® Pentium® III Mobile Processor. In one embodiment, the Phone Module is a Class B device, supporting both General Packet Radio Service (GPRS) and Global Special Mobile (GSM) to manage data, Short Messaging System (SMS), voice and fax transmissions. Dual band 900/1800 and 900/1900 support will ensure international access, without the need for separate modules. The Intel® Embedded StrongARM® 1110 Processor handles mobile contact management, scheduling, and e-mail. In addition, the Intel® StrongARM® 1110 Processor and the GSM Module handle browsing functions via Wireless Application Protocol (WAP). These functions are managed by the Microsoft® PocketPC® (CE) operating system. The Intel® Pentium® III Mobile Processor handles other office automation tasks, such as word processing and spreadsheet manipulation, as well as third-party software applications, and land-line based Internet Protocol (IP) support, all managed by the Microsoft® Windows® Millennium (ME) operating system.

One embodiment of the present invention may be thought of, for the sake of simplicity, as a Personal Computer (PC) and a cellular telephone. These two devices have very different power requirements and user expectations for both stand-by time and use time. In addition to the normal individual power management functions for each of these two devices, the present invention includes an overall system level power management strategy and architecture. This power management strategy allows the device to operate as a cellular telephone independently from the computer in certain modes of operation. In one embodiment, the computer processor is either turned off completely or put into a deep sleep mode any time that the more robust PC functionality is not absolutely needed. For example, when operating as a PDA, the embedded processor, memory and hard disk are used to the exclusion of the PC circuitry and phone module for such functions as contact management and scheduling, having lower power requirements. For browsing and e-mail, the embedded processor, phone module, memory, and hard disk are utilized to the exclusion of the PC circuitry. When operating simply as a cellular telephone, the cellular telephone circuitry, having lower power requirements, is utilized to the exclusion of the PC circuitry and hard disk. In addition, in one embodiment of this invention, when the battery charge level gets too low for computer usage, the power management mechanism shuts down the computer while still allowing enough talk time so that the cellular telephone can continue to operate.

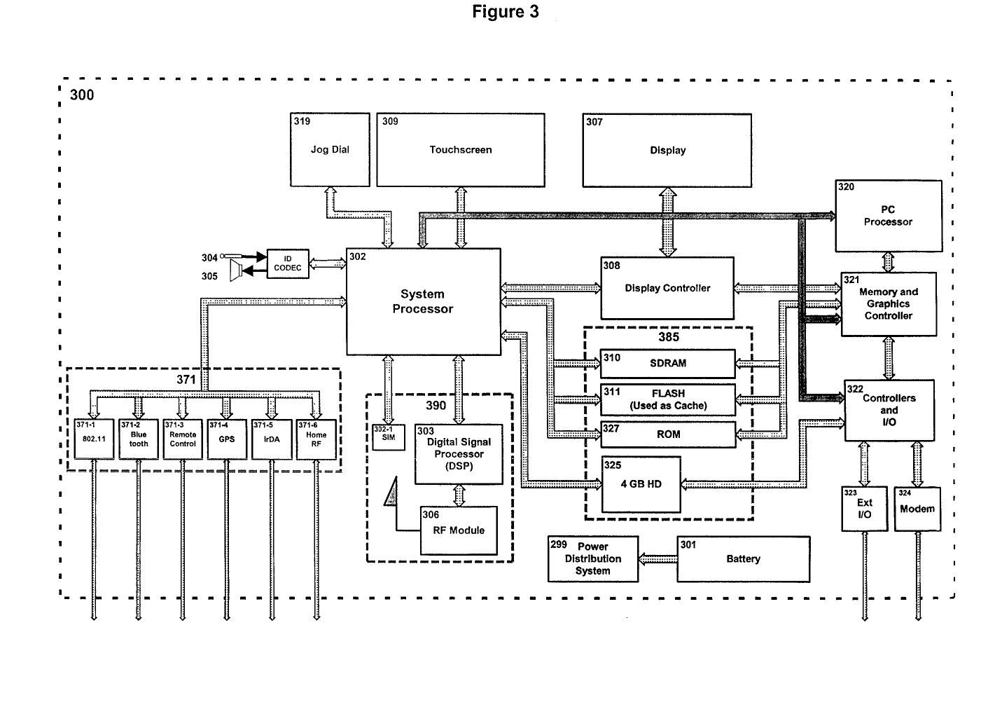

FIG. 3 is a block diagram of one embodiment of this invention, in which Device 300 includes a single Battery 301, which serves to apply power to all of the modules contained within Device 300 via Power Distribution System 299 which is of a type well known to those of ordinary skill of the art and will not be discussed in further detail in this application. In one embodiment, Battery 301 is a Lithium Polymer Battery, for example of 4.5 to 6.0 ampere hour capacity, such as is available from Valence Corporation.

Device 300 includes a System Processor 302, which in one embodiment is processor having lower power requirements and capable of performing more limited functions than a standard computer processor. In one embodiment, in order to achieve this lower power requirement, System Processor 302 is an embedded processor, having a simplified and embedded operating system contained within its on-chip memory. One such embedded processor suitable for use as System Processor 302 is the StrongARM® 1110 Embedded Processor available from Intel. Processor 302 serves as system controller for the entire Electronic Device 300. System Processor 302 includes a number of components as is more fully described, for example, in the Intel® StrongARM® 1110 Technical White paper, such that System Processor 302 is capable of handling contact management, scheduling, and e-mail tasks, as is known in the art, for example in the Hewlett Packard® (HP) Jornada® PocketPC® (CE) device. In this exemplary embodiment, System Processor 302 controls Telephone Module 390, which serves to provide cellular telephone communications, utilizing any one or more communications standards, including CDMA, TDMA, GSM and like. Telephone Module 390 includes Signature Identification Module SIM 302-1, Digital Signal Processor (DSP) 303, and RF Module 306. DSP 303 receives audio input via Microphone 304 and provides audio output via Speaker 305. The operation of Telephone Module 390 is well known and will not be further discussed in detail in this application. In one embodiment, SIM 302-1 is a unique identification encrypted device available from Xircon Company, with DSP 303 being the Digital Signal Processor (DSP) device, and RF Module 306 being the Radio Frequency (RF) device. These components can be purchased, integrated into a GSM module, for example the CreditCard GPRS available from Xircom Corporation. In one embodiment, SIM 302-1 is interchangeable so that a user's phone number does not have to be changed when migrating to Device 300 from a standard cellular phone.

System Processor 302 also serves to control Display 307, which may be any suitable display technology, for example Liquid Crystal Display (LCD). In one embodiment, Display 307 is a LCD Thin Film Transfer (TFT) Reflective Front-Lit Touchscreen display, such as manufactured by Sony® Corporation and used in the iPAQ® 3650 PDA device.

In one embodiment, Display 307 has a resolution of 150 dpi with 65,836 colors available, and is a half SVGA 800×300 dpi. In one embodiment, an aspect ratio of 800×600 is provided but only a fraction of the height (for example only the upper half or lower half) of the actual image is displayed, with jog dial or touchscreen control used to scroll to the upper or lower half of the screen not in view. Display 307 is controlled by Display Controller 308, which serves to receive display information from System Processor 302, and from Processor 320 via Memory and Graphics Controller 321. System Processor 302 instructs Display Controller 308 which display signal sources to be used, i.e., that from System Processor 302 or that from Memory and Graphics Controller 321. System Processor 302 also controls Touchscreen 309 and Jog Dial Module 319, Touchscreen 309 serves as a user input device overlaying Display 307, and is, for example, an integral part of the device from Sony® Corporation. Jog dial Module 319 serves to receive user input applied to the touchscreen and convert these analog signals to digital signals for use by System Processor 302.

Device 300 also includes Processor 320, which serves to perform tasks requiring greater processor power than is available in System Processor 302. For example, in one embodiment Processor 320 can access typical computer programs such as: Windows® ME, and programs running under Windows® ME, such as Word®, Excel®, PowerPoint®, and the like. In one embodiment, Computer Processor 320 is a Transmeta Crusoe® Processor operating at 500 Megahertz. In an alternative embodiment Processor 320 is an Intel® Mobile Pentium III® operating at 300 to 500 Megahertz.

Processor 320 is not used for simpler tasks, which are handled more effectively, particularly with respect to power consumption and without the need to be awakened from sleep, by System Processor 302. Through the use of dual Processors 302 and 320, and thus dual operating systems, the present invention overcomes the inability to reliably “wake up” from a memory based “sleep mode”. By using the embedded operating system of Processor 302 and associated embedded software applications for the highly used “simple applications”, Processor 320 is not required to frequently wake up. Processor 320 is only “woken” to perform non-simple applications, and its sleep mode state is “woken” from the hard disk, rather then from volatile memory.

Such tasks which are, in certain embodiments, performed by System Processor 302 rather than Computer Processor 320, include the control of Telephone Module 390, controlling Display 307, interfacing with Touchscreen 309 Jog Dial Module 319, and Display Controller 308, as well as interfacing with Memory Devices 310 and 311, during operation of Telephone Module 390. In certain embodiments, System Processor 302 also performs additional features suited to its level of computational ability and low power requirements, such as interfacing with hardware elements contained within Accessories Module 371. Such operations include, for example infrared remote control operation using IR Module 371-3, for example for use with entertainment devices. In one embodiment, remote control Module 371-3 is a Universal Remote Control device available from Sony Corporation. In such embodiments, System Processor 302 also performs features associated with Accessory Module 371-1 which, in one embodiment is a Wireless LAN mobile 802.11 device available from 3Com Corporation; operation of Bluetooth® Module 371-2, for example for cordless headset, and cordless telephone, operation with a cordless telephone base station (not shown) connected to a landline and communicating with Device 300 via Bluetooth®. In one embodiment, Bluetooth® Module 371-2 is a Wireless Device available from Philips Corporation. Such other functions which System Processor 302 performs via the Accessory Module 371 includes operation of Global Positioning System (GPS) Module 371-4, in order to provide detailed and accurate positioning, location, and movement information, and the like, as well know to those familiar with GPS Systems. In one embodiment, GPS Module 371-4 is Compact Flash Card device available from Premier Electronics. The built in GPS can be utilized to determine the latitude and longitude of Device 300. This information can be supplied to software applications, such as those which provide driving directions, and eCommerce applications that associate consumers and merchants via latitude and longitude for online ordering, such as the Application Service Provider (ASP) food.com.

In one embodiment, Accessory Module 371 includes IRDA Module 371-5, which is used for point to point wireless IR communications, which in one embodiment is an integrated Transceiver Device available from Novalog Corporation. In one embodiment, Accessory Module 371 includes Home RF Module 371-6, which serves to provide access to a pre-existing 2.4 GHz home wireless communication network, and which, in one embodiment, is a 2.4 GHz Wireless Device available from WaveCom Corporation. In one embodiment Bluetooth and PC synchronization functions between System 300 and other PC computing devices that have utilized the Bluetooth® technology as their wireless interfaces.

In certain embodiments, System Processor 302 also performs more sophisticated tasks, yet tasks which are well suited to its level of computational ability, which is less than that of Processor 320. Such tasks include, for example, Windows® PocketPC® (CE), and programs which may be run under Windows® PocketPC® (CE), for example running Display 307 during the telephone mode, and Pocket Outlook®, including e-mail, contact management, and scheduling.

In the embodiment shown in FIG. 3, Memory and Storage Module 385 serves as a shared resource module which is shared by System Processor 302 and Processor 320, which accesses memory and storage module 385 via Memory and Graphics Controller 321. Memory and Storage Module 385 includes, in this exemplary embodiment, ROM 327 which serves to store the Embedded Operating System, which in one embodiment is Microsoft® PocketPC® (CE), SDRAM 310, which serves as the main memory for Devices 302 and 320 for use by computer programs running on their respective operating systems, Flash Memory 311, which in this embodiment is used as application cache memory, and Hard Disk Drive 325, which in one embodiment is a 4 Gigabyte Micro-Drive such as is available from IBM Corporation. In an alternative embodiment, Hard Disk Drive 325 is a semiconductor device which emulates a hard disk, such as is available Sandisk Corporation. In one embodiment, SDRAM 310 is 64 to 256 megabytes of synchronous dynamic RAM. FLASH Memory 311 typically comprises 256 megabytes of FLASH memory, such as is available from Samsung Corporation. In one embodiment, the available memory is shared but specific memory addresses are not shared. Memory address blocks are not shared or made available to both System Processor 302 and Computer Processor 320 at the same time.

Utilizing Hard Disk Drive 325 as a shared resource between System Processor 302 and Processor 320 provides an enormous data storage capacity available for both processors and eliminates the data storage limitation normally encountered when using typical prior art PDA or similar device utilizing an embedded processor with a limited amount of semiconductor memory. In one embodiment, Hard Disk 325 is artificially partitioned for Microsoft® PocketPC® (CE) data storage space. In another embodiment, Hard Disk 325 shares the file systems between the two operating environments by protecting certain operating environment files, but still allowing for the use of shared files, when appropriate.

Operating with Processor 320 are Memory and Graphics Controller 321, such an Intel® 82815 Graphics Memory Controller Hub (GMCH) device, and Controller and I/O Module 322, for example an Intel® 82801 Integrated Controller Hub (ICH) device, which provides IDE and PCI Controller types of functions, as well as a USB output port suitable for uses such as connecting to the 601 Module as a Docking Strip or Module 700 as a Slave Unit to an existing PC. In an alternative embodiment, Controller and I/O Module 322 is a Intel 82801 ICH device operating in conjunction with a Intel® WA3627 device, which provides additional peripheral device attachments such as floppy drives, additional hard disks, CD-ROMS, DVDs, external mouse, keyboards and external monitor integrated in a combination as to form as to comprise Module 800 as the Docking Station functionality. Controller and I/O Module 322 serve to interface Processor 320 with various I/O devices, such as Hard Disk Drive 325. Other I/O Modules include Modem 324, and other External I/O devices controlled by External I/O Controller 323. Such other External I/O devices include, for example, keyboard, CD ROM Drive, floppy disk drives, mouse, network connection, and so forth.

In one embodiment, System Processor 302 serves as the overall power manager of Device 300. Thus, System Processor 302 determines when Processor 320 will be on, and when it will be in its sleep mode. In one embodiment, System Processor 302 determines the operating speed of Processor 320, for example, based on the tasks being performed by Processor 320, the charge on Battery 301, and user preferences. System Processor 302, as part of its power management tasks, determines which components related to Processor 320 will be turned on when Processor 320 is in operation. Thus, Processor 320 can be operating while one or more of External I/O Controller 323, Modem 324, and Hard Drive 325, are disabled, when those devices are not necessary for the tasks at hand, thus saving power and extending the useful life of Battery 301.

As part of the power management operation, System Processor 302 also determines when Display 307 is illuminated, when Telephone Module 390 is powered up, and the like.

Many of the power management decisions are driven by the user's desire to perform a specific function. For example, in one embodiment, to access Microsoft® Outlook® the following events occur to minimize power requirements, System Processor 302 powers up only Processor 320 and Memory and Graphics Controller 321. In this manner, FLASH Memory 311and SDRAM 310, are accessed via Memory and Graphics Controller 321. Memory and Graphics Controller 321 manages the graphics display of Outlook®, and the Outlook® executable and data file are read from FLASH Memory 311 and/or SDRAM Memory 310. If the User alters the Outlook® data file in FLASH Memory 311 and/or SDRAM Memory 310, such as adding a new contact, then System Processor 302 in conjunction with Memory and Graphics Controller 321 writes the updated information back to FLASH Memory 311 and/or SDRAM Memory 310. When the user exits Outlook®, System Processor 302 writes all necessary data back to FLASH Memory 311 including any data elements residing in SDRAM Memory 310. The following chain of events will then occur:

1. System Processor 302 attempts to wake up Processor 320.

2. If Processor 320 cannot be woken, due to undesirable conditions determined by System Processor 302 and PC elements 320, 321, 322, 323, and 325 (which are now powered up);

2.1. A re-boot of Processor 320 is initiated.

2.2. The PC module reboots Windows® ME in the background. Once the reboot has been completed, then the updated Outlook® data residing in FLASH Memory 311 is written to hard disk version of the data file in Outlook®.

2.3. Once the reboot has been completed, then System Processor 302 returns Processor 320 to sleep mode.

3. On the contrary, if the PC module can be woken, the updated Outlook® data residing in FLASH Memory 311 is written back to the Outlook® data file residing Hard Disk 325.

4. System Processor 302 returns Processor 320 to sleep mode.

As another feature of power management, System Processor 302 manages the duty cycle of Display 307. For example, user input to the touchscreen results in Display 307 power up. The user then taps the cell phone icon on the main menu and the keypad application is invoked loading from FLASH Memory 311. The user taps in a phone number to call and taps the “Send” button. The application dials the phone number stating “Dialing number . . . ” and connects the call displaying “Call Connected”. The application messages to System Processor 302, that the call has been completed and transaction complete. System Processor 302 waits for a period of time, for example 3 seconds, then powers down Display 307 to conserve power. System Processor 302 then is in its “standby” mode, idling and waiting for user input or an incoming call to “wake up”.

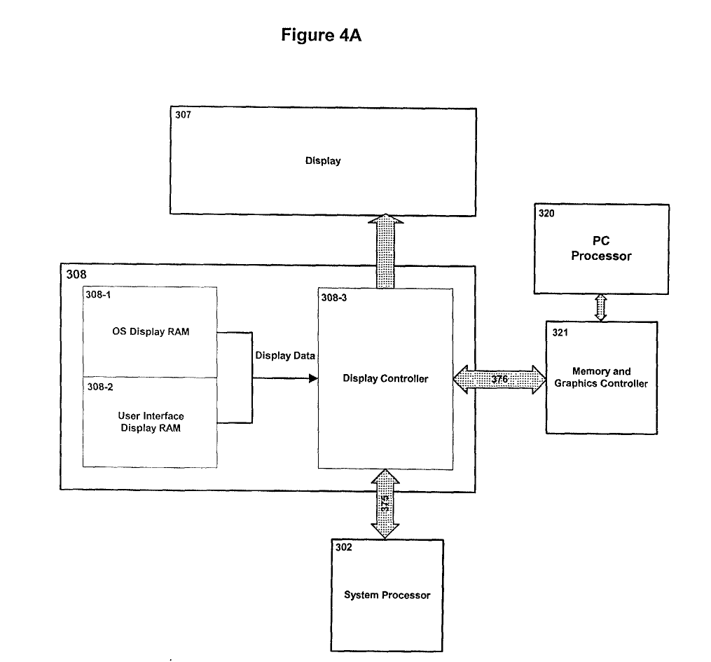

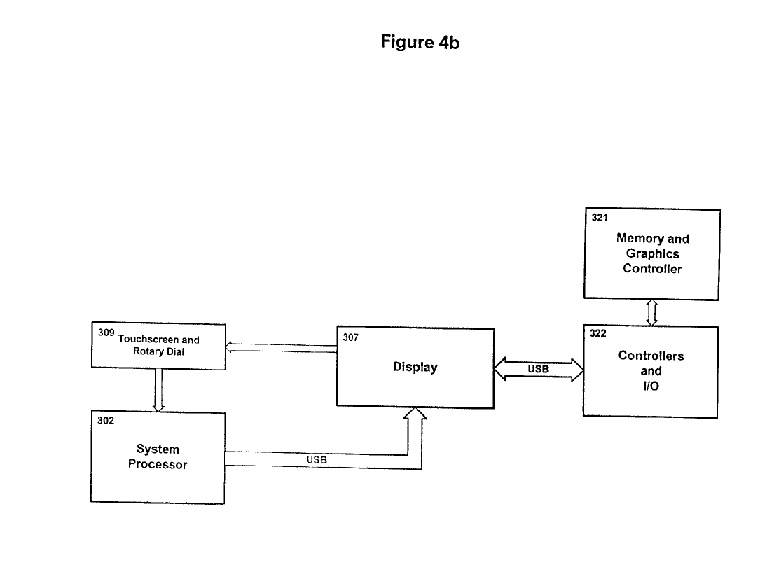

FIG. 4A is a block diagram depicting in more detail Display Controller 308. Shown for convenience in FIG. 4A is also System Processor 302, Memory and Graphics Controller 321, and Display 307. In one embodiment, Display Controller 308 includes memory, which includes two portions, Windows® Display RAM 308-1, and User Interface Display RAM 308-2. Memory 308-1 and 308-2 is, in one embodiment, dual ported RAM allowing communication with both System Processor 302 and Memory and Graphics Controller 321. In an alternative embodiment, Memory 308 is not dual ported, but rather is divided into two portions of high speed synchronous RAM, with System Processor 302 and Processor 320 being allocated their own separate portions of RAM 308.

Windows® Display Memory 308-1 receives from both System Processor 302 and Processor 320, as appropriate, the frame data, which forms part of the definition of the image to be displayed on LCD 307. User Interface Display RAM 308-2 receives from System Processor 302 and Processor 320, as appropriate, pixel data for use with the frame data stored in the Windows® Display RAM 308-1, which will complete the information needed to provide the desired display on Display 307. Display Controller 308-3 serves to retrieve data from Windows® Display Data RAM 308-1 and User Interface display RAM 308-2 to provide the desired display on Display 307. Display Controller 308-3 communicates with System Processor 302 via Control Bus 375, and also communicates with Memory and Graphics Controller 321 via Control Bus 376.

FIG. 4B is an alternative embodiment, in which System Processor 302 and Memory Controller 321 communicate with Display 307 utilizing separate display controllers contained within System Processor 302 and Memory Controller 321, respectively. In this embodiment, Display Controller 401 is provided, which includes a selection circuit operating under the control of System Processor 302 for selecting video display signals received from the display controller contained in System Processor 302 or, alternatively, signals from the display controller contained in Controllers and I/O Module 322, under the control of Memory and Graphics Controller 321. For example, when System Processor 302 is an embedded StrongARM® 1110 Processor device available from Intel®, it contains its own Display Controller with USB Input/Output (I/O). Similarly, Graphics and Memory Display Controller 321, which in one embodiment is an 82801 GMCH device available from Intel®, communicates with I/O Module 322, which in one embodiment is an 82801 ICH device available from Intel® having its own USB output as well. In this embodiment, USB connections provide communications between System Processor 302 and Display 307, and between Controllers and I/O Module 322 and Display 307. In this embodiment, the processing of display data occurs within Controllers residing in Device 302 and 321. In this embodiment, Display Controller 401 acts as a switching device, not a processing device, between the two Controllers, described above.

As a feature of certain embodiments of this invention, Device 300 operates using two processors, each utilizing its own operating system. This allows Device 300 to take advantage of the “best of breed” from both embedded and non-embedded operating environments. For example, the embedded operating system of System Processor 302 is self-contained, and the software applications that run within the embedded operating environment are considered “closed”. Specifically, in a “closed” environment, the software used is specified by the developer of the embedded system, and may not be upgraded, or modified by the user of the embedded operating system. In addition, no new software may be introduced to the embedded system by the user; the Microsoft® PocketPC Operating System, and Microsoft® Outlook for the PocketPC, are examples of a “closed” embedded operating system, and a “closed” embedded software application residing in a “closed” environment.

The ability to debug and test an embedded system without the concern of a user introducing new software or modifications, or patches to the system, which could introduce bugs or viruses to the embedded system, make the ability to create a stable operating environment much easier by orders of magnitude, compared to an “open” software environment. Therefore, by definition, an embedded operating environment is inherently more reliable and stable for the reasons described above.

Device 300 has been designed to take full advantage of the “closed” embedded environment by using an embedded operating system, and embedded software applications that are considered to be “simple” and “high-use” applications, as it regards duty-cycle usage, and more importantly, the reliability of Device 300, for such functions as cellular telephone calls, scheduling appointments, sending and receiving e-mail, and web browsing. In addition to the reliability benefits, which are tremendous, the embedded environment has dramatically lower power consumption, when compared to Processor 320 and its related components, if used to perform the same tasks.

Conversely, an “open” software operating environment, such as is the case with the PC Module (Processor 320 and its related devices 321, 322, and 325); the user is free to add, modify and delete software applications and data files at will. Device 300 has also provided to the user an “open” operating environment, with an industry standard operating system, allowing for the use of industry standard software. The user of Device 300 is free to load and manipulate software and data files that reside in the “open” operating environment of the PC Module, without fear of corrupting the core functionality of the entire device. The “open” environment provides a tremendous amount of PC use flexibility, unfortunately, since there is no guarantee of compatibility between the new software being introduced or modified in the “open” environment, it increases the possibility of system failures which is why, in addition to greater power consumption, the PC Module is not used as the System Processor/Controller exclusively in Device 300.

In one embodiment Voice Command and Control is provided in one or both the embedded operating environment of System Processor 302 and the non-embedded operating environment of Processor 320. When used in both operating system environments, a seamless Voice Command and Control user experience is achieved, regardless of the operating mode of Device 300. In one embodiment, Voice Recognition is provided as well, for example by way of voice recognition software run by Processor 320.

Power management is very important in that Device 300 includes a number of elements which need not always be powered. By selectively powering down certain elements, the useful life of Battery 301 is extended considerably. Table 1 shows, by way of example, a variety of functions, and the associated power management scheme for various modules.

For example, in one embodiment while mobile and using power available via Battery 301, the Microsoft® PocketPC® (CE) Operation System is used in conjunction with System Processor 302, Memory 310, ROM 327, and Hard Disk 325 for the major computing tasks. Computing tasks for use in this mode typically include e-mail, contact management, calendar functions, and wireless browsing. In this operating environment, power is managed by putting the other modules into a sleep mode or turning them completely off.

Synchronization of the data files between the embedded Microsoft® PocketPC® (CE) and the Windows® ME PC modules, by turning the PC Module “On” and using customized synchronization software to update the Windows® ME PC Module data files. There are certain user functions that are shared between the two operating environments of Microsoft® PocketPC® (CE) and Microsoft® Windows® ME. These functions include, but are not limited to, for example, the Outlook data file, which includes contact management, e-mail and calendar data, and favorite site data, stored in Microsoft® Internet Explorer® (IE). The applications that are used to perform the functions, described above, are redundant, in that they exist within each operating environment. These applications, although identical in functionality are, from a software architecture perspective, dramatically different in nature, and were programmed to maximize their use in each environment. Specifically, the embedded version of Outlook, in the Microsoft® PocketPC® (CE) operating environment, for example, was optimized with the smallest footprint in memory, in order to operate the application in an environment having a less powerful processor and limited memory. Such is not the case with the Microsoft® Windows® ME Outlook version, where a complete Windows object library is used to construct the Outlook application. If redundant or unused object functionality is loaded and processed into memory, the inefficiencies are ignored, because since the PC processor is so fast there is no cost benefit to optimization. In accordance with this invention, in order to ensure the best user experience and maintain the highest level of functionality such application data is seamlessly and silently updated and synchronized between the two operating systems and applications.

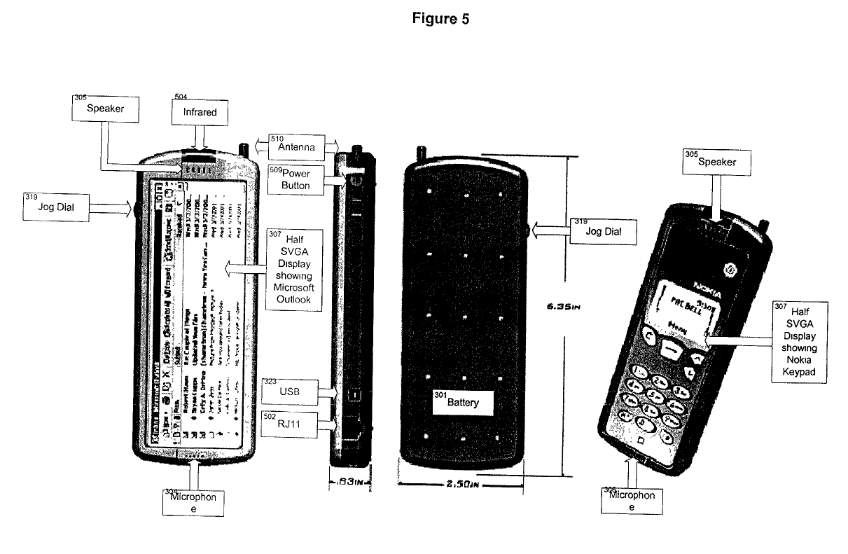

FIG. 5 is a diagram depicting one embodiment of the present invention, including Jog Dial 319, RJ11 Jack 502 for connection to, for example, a telephone line or network interface, and USB Connection 323. In addition, Microphone 304 and Speaker 305; Infrared for remote control and data synchronization 504; Display 307, Antenna 510, and Power On/Off 509 are shown.

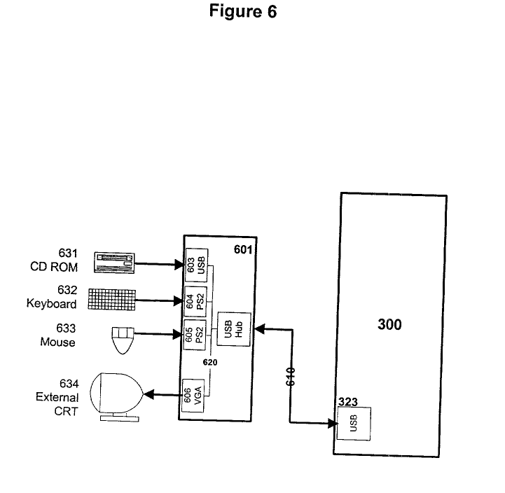

FIG. 6 is a diagram depicting Device 300 in use with external computer accessories, for example, when the user arrives at a home or business office and wishes to use more conventional I/O Devices. Device 300, in this embodiment, includes as External I/O interface 323 a Universal Serial Bus (USB) interface. Docking Strip 601 serves to interface between External I/O Modules and Device 300. As shown in FIG. 6, Docking Strip 601 includes a multi-port USB Hub 602, which communicates via USB Cable 610 with Device 300. Multi-port USB Hub 602, in turn interfaces to various External I/O interfaces, shown in this example as USB Interface 603, which is connected to, for example CD ROM Drive 631; PS2 Interface 604, which is connected to, for example Keyboard 632; PS/2 Interface 605, which is connected to, in this example Mouse 633; and VGA Interface 606 which, in this embodiment, is connected to external CRT or LCD Video Display 634. In this fashion, the simple, low power Device 300 is able to be easily, and inexpensively, connected to a wide variety of external, and more conventional I/O Devices, some examples of which are shown in the embodiment of FIG. 6. In one embodiment, Docking Strip 601 receives what little power requirements it has, via USB cable 610 from Device 300. In this embodiment, certain External I/O Devices, such as CD ROM Drive 631 and Display 634, receive their power from the AC supply, thereby not adding to the power requirements, which must be met by Device 300.

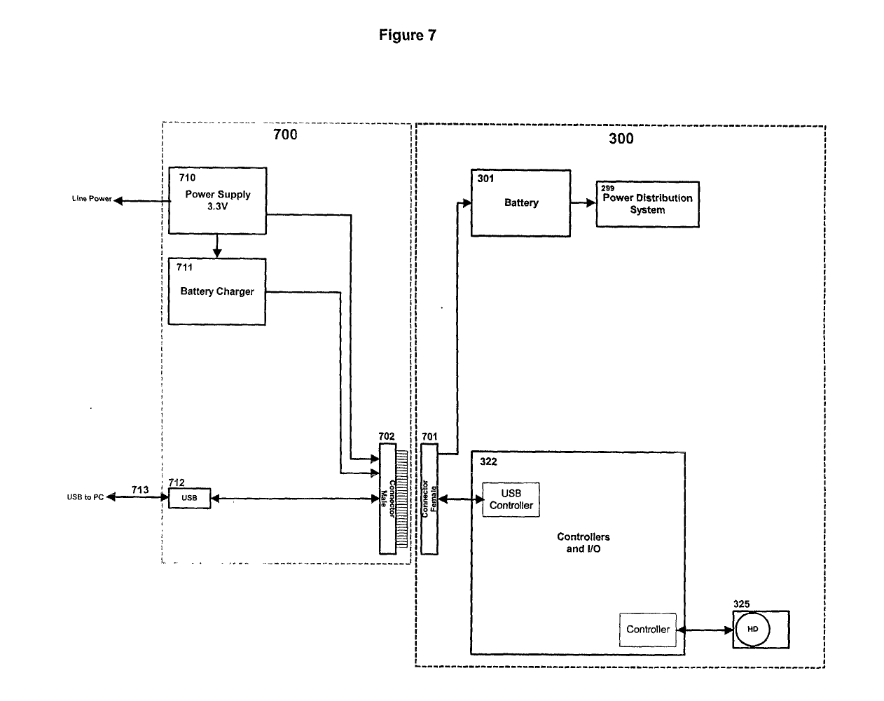

FIG. 7 is a diagram depicting Device 300 in use with another computer system (not shown) so that, for example, the other computer system is able to access the memory and data storage elements of Device 300. This is useful, for example, when a traveler returns to a fixed location, such as home or work office, hotel room, and so forth, and desires to utilize a standard computer system (which might include a network connection) to access the data within Device 300. Conveniently, during this operation, Battery 301 of Device 300 can be recharged.

Referring to FIG. 7, Slave Unit 700 serves to interface between a conventional computer (not shown), for example via USB cable 713, and Device 300. In one embodiment, Device 300 includes a Connector 701, which serves to mate with Connector 702 of Slave Unit 700. Such connectors are well known in the art. Slave Unit 700 also includes Power Supply 710 and Battery Charger 711 (which in one embodiment are conveniently constructed as a single module), which receives power from an external power source and provides power, via connector 702 to connector 701, in order to charge Battery 301 within Device 300. This battery charging is conveniently performed while the external computer system is accessing the memory and storage device (such as Hard Disk Drive 325) within Device 300.

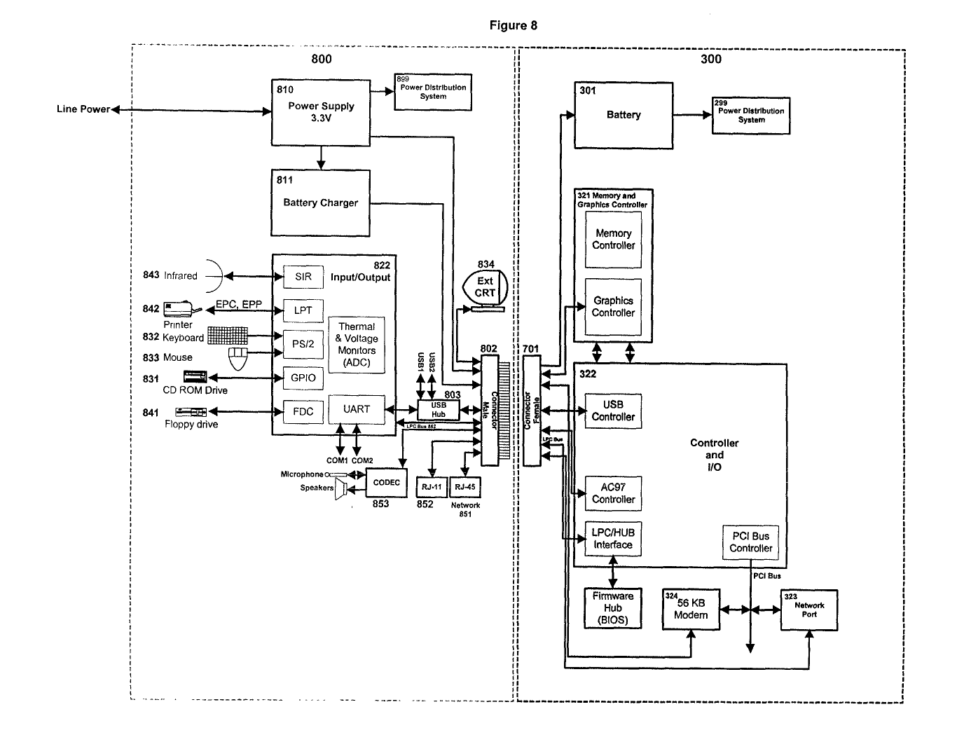

FIG. 8 is a block diagram showing one embodiment of a Docking Station 800 for use with Device 300. Various elements contained within Device 300 are shown, which have particular relevance to interconnection with Docking Station 800. Also shown within Device 300 is a network port (for example, Ethernet port) serving as External I/O Interface 323. Docking Station 800 includes Connector 802 for connection to Device 300 via its connector 701. In one embodiment, Docking Station 800 includes Power Supply 810 and Battery Charger 811, which in one embodiment are fabricated as a single module, which receive power from an external source in order to supply Docking Station 800, as well as provide battery charging current to Device 300. Docking Station 800 includes, for example, an external CRT or LCD Display 834, and USB Hub 803 for connection with Device 300 Controller and I/O Module 322. USB Hub 802 connects to Docking Station I/O Module 822 and other USB devices (not shown), if desired. Alternatively, I/O Module 822 of Docking Station 800 is connected to Device 300 via LPC Bus 862, as an alternative interface. Other types of interfaces could be used as well. I/O module 822 serves to communicate with Device 300 and various I/O Modules, shown by way of example, as Infrared I/O Module 843; Printer 842; Keyboard 832; Mouse 833; CD ROM Drive 831; and Floppy Drive 841. Any other desired I/O Modules can, of course, be used in similar fashion. In the embodiment shown, External I/O Module 323 of Device 300 is a network port, for example an Ethernet port. This network port is coupled via connectors 701 and 802 to Network Connection 851, allowing Device 300 to be connected to a network. In the embodiment shown in FIG. 8, Device 300 includes Modem 324 which is connected to a Telephone Line 852 by a connection through connectors 701 and 802.

In the embodiment shown in FIG. 8, Docking Station 800 includes its own CODEC 853, as well as one or more microphones and one or more speakers, allowing the audio input-output to be performed with elements of Docking Station 800, rather than integral elements of Device 300.

In one embodiment, when Device 300 is docked with Docking Station 800, Display Controller 308 automatically turns off Display 307, and uses the Docking Station Monitor 834. Display Controller 308 automatically provides display signals to Docking Station Monitor 834 to provide a full SVGA display of 800×600. If desired, Docking Station Monitor 834 is custom configurable through the use of Display Controller 308 to set the Docking Station Monitor at higher resolutions.

In one embodiment, when Device 300 is docked within Docking Station 800, telephone module 390 is able to be used concurrently with the landline based telephone connection 852, allowing, for example, a voice telephone call to be made concurrently with a modem connection, and two concurrent (and/or conjoined) telephone connections.

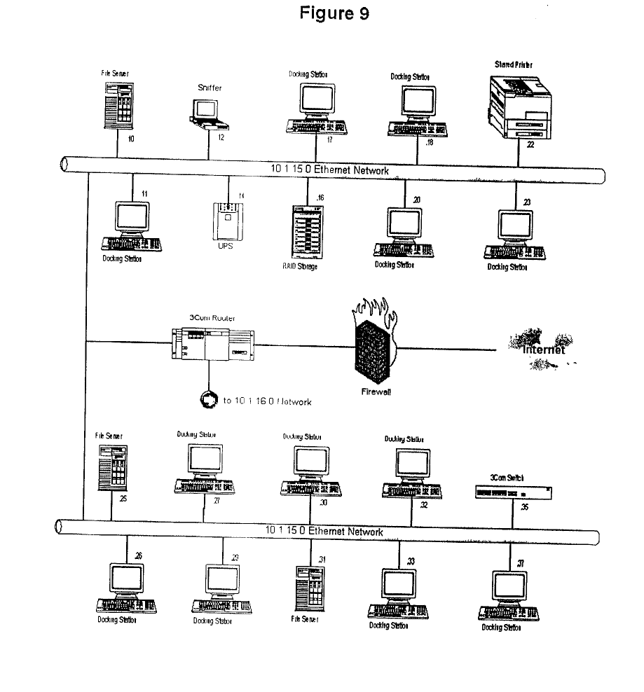

FIG. 9 is a block diagram depicting a typical Local Area Network (LAN), including one or more personal electronic devices of the present invention, which are connected to the network either directly, of via network drivers contained within the personal electronic device, a network connection contained in Docking Strip 601, or the network connection provided by Docking Station 800 of FIG. 8.

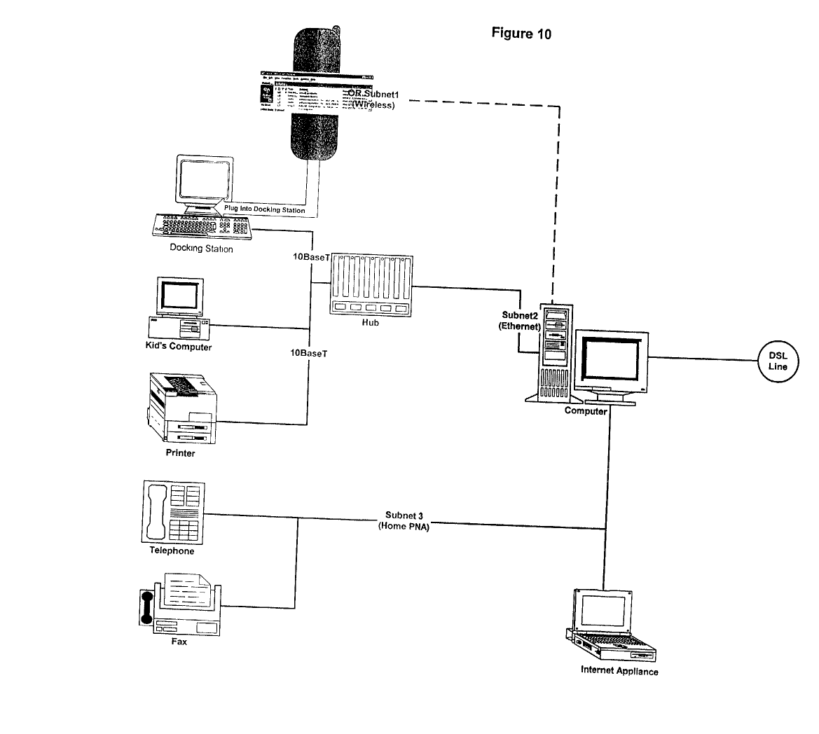

FIG. 10 is a diagram of a home network, where there are several different network connectivity examples, such as a wireless 802.11 LAN, a standard Ethernet LAN and a Home Phone Network Alliance (PNA) all integrated into one solution, for one home network.

All publications and patent applications mentioned, in this specification, are herein incorporated by reference to the same extent as if each individual publication or patent application was specifically and individually, indicated to be incorporated by reference.

The invention now being fully described, it will be apparent to one of ordinary skill in the art that many changes and modification can be made thereto without departing from the spirit or scope of the appended claims.

TABLE 1

| | 302 | 390 | 307 | 308 | 320 | 321 | 322 | 310 | 325 | 322 | 324 | 323 | 301 | 834 |
|---|---|---|---|---|---|---|---|---|---|---|---|---|---|---|
| | System | Teleph | | Display | PC | | | | | Super | LL | | | |
| | Proc | Module | Display | Controller | Processor | GMCH | ICH | SDRAM | HD | I/O | Modem | Ethernet | Battery | Monitor |
| Function | | | | | | | | | | | | | | |
| Mobile | | | | | | | | | | | | | | |
| E-Mail- | ON | ON | OFF | OFF | SLEEP | ON | OFF | ON | ON | OFF | OFF | OFF | ON | OFF |
| Receive | | | | | | | | | | | | | | |
| E-Mail-Send | ON | ON | ON | ON | SLEEP | ON | OFF | ON | ON | OFF | OFF | OFF | ON | OFF |
| E-Mail-Read | ON | OFF | ON | ON | SLEEP | ON | OFF | ON | ON | OFF | OFF | OFF | ON | OFF |
| E-Mail- | ON | OFF | ON | ON | ON | ON | OFF | ON | ON | OFF | OFF | OFF | ON | OFF |
| Attachments | | | | | | | | | | | | | | |
| Contact | ON | OFF | ON | ON | SLEEP | ON | OFF | ON | OFF | OFF | OFF | OFF | ON | OFF |
| Manage- | | | | | | | | | | | | | | |
| ment-Read | | | | | | | | | | | | | | |
| Contact | ON | OFF | ON | ON | SLEEP | ON | OFF | ON | OFF | OFF | OFF | OFF | ON | OFF |
| Manage- | | | | | | | | | | | | | | |
| ment-Write | | | | | | | | | | | | | | |
| Calendar- | ON | OFF | ON | ON | SLEEP | ON | OFF | ON | OFF | OFF | OFF | OFF | ON | OFF |
| Read | | | | | | | | | | | | | | |
| Calendar- | ON | OFF | ON | ON | SLEEP | ON | OFF | ON | ON | OFF | OFF | OFF | ON | OFF |
| Write | | | | | | | | | | | | | | |
| Web | ON | ON | ON | ON | SLEEP | ON | OFF | ON | OFF | OFF | OFF | OFF | ON | OFF |
| Browsing | | | | | | | | | | | | | | |
| Cell Phone- | ON | ON | ON | ON | SLEEP | SLEEP | OFF | ON | OFF | OFF | OFF | OFF | ON | OFF |
| Dial | | | | | | | | | | | | | | |
| Cell Phone- | ON | ON | OFF | OFF | SLEEP | SLEEP | OFF | SLEEP | OFF | OFF | OFF | OFF | ON | OFF |
| Connect | | | | | | | | | | | | | | |
| Cell Phone- | ON | ON | OFF | OFF | SLEEP | SLEEP | OFF | SLEEP | OFF | OFF | OFF | OFF | ON | OFF |
| Talk | | | | | | | | | | | | | | |
| Cell Phone- | ON | OFF | OFF | OFF | SLEEP | SLEEP | OFF | SLEEP | OFF | OFF | OFF | OFF | ON | OFF |
| Terminate | | | | | | | | | | | | | | |
| Word | SLEEP | OFF | ON | ON | ON | ON | ON | ON | ON | OFF | OFF | OFF | ON | OFF |
| Excel | SLEEP | OFF | ON | ON | ON | ON | ON | ON | ON | OFF | OFF | OFF | ON | OFF |
| Third Party | SLEEP | OFF | ON | ON ON | ON | ON | ON | ON | OFF | OFF | OFF | ON | OFF | |
| Applications | | | | | | | | | | | | | | |
| Synchroniza- | ON | OFF | OFF | OFF | ON | ON | ON | ON | ON | OFF | OFF | OFF | ON | OFF |
| tion CE to | | | | | | | | | | | | | | |
| ME | | | | | | | | | | | | | | |
| Synchroniza- | ON | OFF | OFF | OFF | ON | ON | ON | ON | ON | OFF | OFF | OFF | ON | OFF |
| tion ME to | | | | | | | | | | | | | | |
| CE | | | | | | | | | | | | | | |
| Function | | | | | | | | | | | | | | |
| Docked | | | | | | | | | | | | | | |
| E-Mail- | SLEEP | OFF | OFF | OFF | ON | ON | ON | ON | ON | ON | ON | ON | CHARGE | ON |
| Receive | | | | | | | | | | | | | | |
| E-Mail-Send | SLEEP | OFF | OFF | OFF | ON | ON | ON | ON | ON | ON | ON | ON | CHARGE | ON |
| E-Mail-Read | SLEEP | OFF | OFF | OFF | ON | ON | ON | ON | ON | ON | OFF | ON | CHARGE | ON |
| E-Mail- | SLEEP | OFF | OFF | OFF | ON | ON | ON | ON | ON | ON | OFF | ON | CHARGE | ON |
| Attachments | | | | | | | | | | | | | | |
| Contact | SLEEP | OFF | OFF | OFF | ON | ON | ON | ON | ON | ON | OFF | ON | CHARGE | ON |
| Manage- | | | | | | | | | | | | | | |
| ment-Read | | | | | | | | | | | | | | |
| Contact | SLEEP | OFF | OFF | OFF | ON | ON | ON | ON | ON | ON | OFF | ON | CHARGE | ON |
| Manage- | | | | | | | | | | | | | | |
| ment-Write | | | | | | | | | | | | | | |
| Calendar- | SLEEP | OFF | OFF | OFF | ON | ON | ON | ON | ON | ON | OFF | ON | CHARGE | ON |
| Read | | | | | | | | | | | | | | |
| Calendar- | SLEEP | OFF | OFF | OFF | ON | ON | ON | ON | ON | ON | OFF | ON | CHARGE | ON |
| Write | | | | | | | | | | | | | | |
| Web | SLEEP | ON | OFF | OFF | ON | ON | ON | ON | ON | ON | ON | ON | CHARGE | ON |
| Browsing | | | | | | | | | | | | | | |
| Cell Phone- | ON | ON | OFF | OFF | ON | ON | ON | ON | ON | ON | OFF | ON | CHARGE | ON |
| Dial | | | | | | | | | | | | | | |
| Cell Phone- | ON | ON | OFF | OFF | ON | ON | ON | ON | ON | ON | OFF | ON | CHARGE | ON |
| Connect | | | | | | | | | | | | | | |
| Cell Phone- | ON | ON | OFF | OFF | ON | ON | ON | ON | ON | ON | OFF | ON | CHARGE | ON |
| Talk | | | | | | | | | | | | | | |
| Cell Phone- | SLEEP | OFF | OFF | OFF | ON | ON | ON | ON | ON | ON | OFF | ON | CHARGE | ON |
| Terminate | | | | | | | | | | | | | | |
| Word | SLEEP | OFF | OFF | OFF | ON | ON | ON | ON | ON | ON | OFF | ON | CHARGE | ON |
| Excel | SLEEP | OFF | OFF | OFF | ON | ON | ON | ON | ON | ON | OFF | ON | CHARGE | ON |
| Third Party | SLEEP | OFF | OFF | OFF | ON | ON | ON | ON | ON | ON | OFF | ON | CHARGE | ON |
| Applications | | | | | | | | | | | | | | |
| Synchroniza- | ON | OFF | OFF | OFF | ON | ON | ON | ON | ON | ON | OFF | ON | CHARGE | ON |
| tion CE to | | | | | | | | | | | | | | |
| ME | | | | | | | | | | | | | | |
| Synchroniza- | ON | OFF | OFF | OFF | ON | ON | ON | ON | ON | ON | OFF | ON | CHARGE | ON |
| tion ME to | | | | | | | | | | | | | | |
| CE | | | | | | | | | | | | | | |

What is claimed is:

1. A portable telephone comprising:
telephone circuitry;
a display;
a touchscreen;
a first processor to provide one of a plurality of telephone user interface images to said display and receive user input from corresponding locations on said touchscreen.

2. A device as in claim 1 wherein at least one of said plurality of telephone user interface images is user defined.

3. A device as in claim 1 which further comprises:
a switch to initiate operation of one or both of said display and said touchscreen.

4. A device as in claim 4 wherein said first processor also serves to display other functional images to said display.

5. A device as in claim 1 wherein said other functional images are selected from the group consisting of:
a contact manager scheduler, e-mail, cell phone and PC based software applications.

6. A device as in claim 1, which further comprises a second processor to provide user interface images to said display, and receive user input from said touchscreen, for use with tasks run by said second processor.

7. A device as in claim 6 wherein said first processor utilizes a first operating system, and said second processor utilizes a second operating system.

8. A device as in claim 6, wherein said first and second processors are coupled to said display via a shared display interface.

9. A device as in claim 8, wherein said display interface comprises:
a first set of memory locations for use by said first processor;
a second set of memory locations for use by said second processor;
control circuitry for selecting data from either said first or said second set of memory locations, to provide user interface image data to said display.

10. A device as in claim 6 which further comprises:
a first set of memory locations for use by said first processor; and
a second set of memory locations for use by said second processor.

11. A device as in claim 6 which further comprises:
a memory having a plurality of memory locations shared by said first and second processors.

12. A device as in claim 6 which further comprises:
a storage device shared by said first and second processors.

13. A device as in claim 7 which further comprises:
a first set of memory locations for use by said first processor; and
a second set of memory locations for use by said second processor.

14. A device as in claim 7 which further comprises:
a memory having a plurality of memory locations shared by said first and second processors.

15. A device as in claim 7 which further comprises:
a storage device shared by said first and second processors.

16. A device as in claim 1 which further comprises a removable Signature Identification Module.

17. A device as in claim 9 wherein said control circuitry is controlled by said first processor.

18. A device as in claim 1 which further comprises one or more modules managed by said first processor, selected from the group consisting of:
a cellular telephone module;
a cordless telephone module;
a wireless headset module;
a wireless interface module;
an electronic remote control module;
a GPS module;
a voice command and control module; and
a voice recognition module.

19. A device as in claim 18 wherein one or more of said cordless telephone module, said wireless headset module, and said wireless interface module comprise Bluetooth enabled modules.

20. A device as in claim 18, wherein said first processor provides to said display user interface images associated with one or more of said selected modules.

21. A device as in claim 6, wherein said second processor comprises a processor more powerful than said first processor and capable of quickly receiving state-of-the-art PC software applications

22. A device as in claim 6, wherein said first processor controls one or more parameters of said second processor.

23. A device as in claim 22, wherein said one or more parameters of said second processor are selected from the group of parameters consisting of: clock speed, duty cycle, sleep mode and power consumption.

24. A device as in claim 18, wherein said first processor controls one or more parameters of one or more of said modules.

25. A device as in claim 24, wherein said one or more parameters of said modules are selected from the group of parameters consisting of: clock speed, duty cycle, sleep mode, and power consumption.

26. A portable telephone comprising:
telephone circuitry;
a display;
a touchscreen;
a first processor, to provide at least one telephone user interface image to said display and receive user input from corresponding locations on said touchscreen; and
a second processor, to provide one or more user interface images to said display and receive user input from corresponding locations on said touchscreen, for use with tasks run by said second processor.

27. A device as in claim 26 wherein said first processor utilizes a first operating system, and said second processor utilizes a second operating system.

28. A device as in claim 26 wherein at least one of said plurality of telephone user interface images is user defined.

29. A device as in claim 26 which further comprises:
a switch to initiate operation of one or both of said display and said touchscreen.

30. A device as in claim 26 wherein said first processor also serves to display other functional images to said display.

31. A device as in claim 30 wherein said other functional images are selected from the group consisting of:
a contact manager scheduler, e-mail, cellular telephone, and PC based software applications.

32. A device as in claim 26 wherein said first and second processors are coupled to said t display via a shared display interface.

33. A device as in claim 32 wherein said t display interface comprises:
a first set of memory locations for use by said first processor;
a second set of memory locations for use by said second processor; control circuitry for selecting data from either said first or said second set of memory locations, to provide user interface image data to said display.

34. A device as in claim 26 which further comprises:
a first set of memory locations for use by said first processor; and
a second set of memory locations for use by said second processor.

35. A device as in claim 26 which further comprises:
a memory having a plurality of memory locations shared by said first and second processors.

36. A device as in claim 26 which further comprises:
a storage device shared by said first and second processors.

37. A device as in claim 27 which further comprises:
a first set of memory locations for use by said first processor; and
a second set of memory locations for use by said second processor.

38. A device as in claim 27 which further comprises:
a memory having a plurality of memory locations shared by said first and second processors.

39. A device as in claim 27 which further comprises:
a storage device shared by said first and second processors.

40. A device as in claim 26 which further comprises a removable Signature Identification Module.

41. A device as in claim 26 wherein said control circuitry is controlled by said first processor.

42. A device as in claim 26 which further comprises one or more modules managed by said first processor, selected from the group consisting of:
a cellular telephone module;
a cordless telephone module;
a wireless headset module;
a wireless interface module;
an electronic remote control module;
a GPS module;
a voice command and control module; and
a voice recognition module.

43. A device as in claim 42 wherein one or more of said cordless telephone module, said wireless headset module, and said wireless interface module comprise Bluetooth enabled modules.

44. A device as in claim 33, wherein said first processor provides to said display user interface images associated with one or more of said selected modules.

45. A device as in claim 26 wherein said second processor comprises a processor more powerful than said first processor and capable of quickly receiving state-of-the-art PC software applications.

46. A device as in claim 26 wherein said first processor controls one or more parameters of said second processor.

47. A device as in claim 46, wherein said one or more parameters of said second processor are selected from the group of parameters consisting of:
clock speed, duty cycle, sleep mode and power consumption.

48. A device as in claim 42, wherein said first processor controls one or more parameters of one or more of said modules.

49. A device as in claim 48, wherein said one or more parameters of said modules are selected from the group of parameters consisting of:
clock speed, duty cycle, sleep mode, and power consumption.

50. A portable electronic device comprising:
a display;
a touchscreen;
a first processor to provide at least one user interface image to said display and receive user input from corresponding locations on said touchscreen; and
a second processor to provide one or more user interface images to said display and receive user input from corresponding locations on said touchscreen, for use with tasks run by said second processor.

51. A device as in claim 50 wherein said first processor utilizes a first operating system, and said second processor utilizes a second operating system.

52. A device as in claim 50 wherein said at least one user interface image provided by said first processor are selected from the group consisting of:
a contact manager scheduler, e-mail, cell phone and PC based software applications.

53. A device as in claim 50, wherein said first and second processors are coupled to said display via a shared display interface.

54. A device as in claim 53, wherein said display interface comprises:
a first set of memory locations for use by said first processor;
a second set of memory locations for use by said second processor;
control circuitry for selecting data from either said first or said second set of memory locations, to provide user interface image data to said display.

55. A device as in claim 50 which further comprises:
a first set of memory locations for use by said first processor; and
a second set of memory locations for use by said second processor.

56. A device as in claim 50 which further comprises:
a memory having a plurality of memory locations shared by said first and second processors.

57. A device as in claim 50 which further comprises:
a storage device shared by said first and second processors.

58. A device as in claim 51 which further comprises:
a first set of memory locations for use by said first processor; and
a second set of memory locations for use by said second processor.

59. A device as in claim 51 which further comprises:
a memory having a plurality of memory locations shared by said first and second processors.

60. A device as in claim 51 which further comprises:
a storage device shared by said first and second processors.

61. A device as in claim 50 wherein said control circuitry is controlled by said first processor.

62. A device as in claim 50 which further comprises one or more modules managed by said first processor, selected from the group consisting of:
a cellular telephone module;
a cordless telephone module;
a wireless headset module;
a wireless interface module;
an electronic remote control module;
a GPS module;
a voice command and control module; and
a voice recognition module.

63. A device as in claim 62 wherein one or more of said cordless telephone module, said wireless headset module, and said wireless interface module comprise Bluetooth enabled modules.

64. A device as in claim 62, wherein said first processor provides to said display user interface images associated with one or more of said selected modules.

65. A device as in claim 50, wherein said second processor comprises a processor more powerful than said first processor and capable of quickly receiving state-of-the-art PC software applications.

66. A device as in claim 50 wherein said first processor controls one or more parameters of said second processor.

67. A device as in claim 66, wherein said one or more parameters of said second processor are selected from the group of parameters consisting of:
clock speed, duty cycle, sleep mode, power consumption.

68. A device as in claim 62, wherein said first processor controls one or more parameters of one or more of said modules.

69. A device as in claim 68, wherein said one or more parameters of said modules are selected from the group of parameters consisting of:
clock speed, duty cycle, sleep mode, power consumption.

70. A computer system comprising:
a monitor;
one or more user input devices;
a docking station, comprising:
a connector for interfacing with portable telephone comprising:
telephone circuitry;
a display;
a touchscreen;
a first processor to provide at least one telephone user interface image to said display and receive user input from corresponding locations on said touchscreen; and
a second processor to provide one or more user interface images to said display and receive user input from corresponding locations on said touchscreen, for use with tasks run by said second processor; and
a power source for powering said portable telephone via said connector.

71. A device as in claim 70 wherein said first processor utilizes a first operating system, and said second processor utilizes a second operating system.

72. A device as in claim 70 which further comprises structure for:
creating image data defining an image of X pixels wide by Y pixels high;
displaying on said display a portion of said image equal to X pixels wide and Y/N pixels high; and
displaying on said monitor said image of X pixels wide by Y pixels high.

73. A device as in claim 72 where N equals two.

74. A device as in claim 70 which further comprises structure for:
displaying on said display a portion of said image equal to X1 pixels wide and Y1 pixels high; and
displaying on said monitor said image of X2 pixels wide by Y2 pixels high.

75. A device as in claim 70 wherein said docking station comprises a telephone connection, and means for operating said telephone connection concurrently with the operation of said telephone circuitry, achieving two concurrent telephone sessions.

76. A computer system as in claim 70 which further comprises one or more user input devices selected from the group consisting of keyboard, mouse, tablet, touchscreen, joystick, and speech recognition unit.

77. A computer system as in claim 70 wherein said docking station comprises a computer.

78. A computer system as in claim 77 wherein said computer uses said portable telephone as a slave device.

79. A computer system as in claim 70 wherein said docking station includes audio interfaces for use by said Electronic Device while said Electronic Device is interfaced with said connector.

80. A computer system as in claim 79, further comprising voice command and control to operate one or more functions of said computer system via user voice command.

81. A system as in claim 80 wherein said voice command and control serves to control at least one function of said first processor and at least one function of said second processor.

82. A computer system as in claim 70 wherein said docking station comprises a network connection, allowing said Electronic Device to connect to said network.

83. A computer system comprising:
a monitor;
one or more user input devices;
a docking station, comprising:
a connector for interfacing with portable electronic device comprising:
a display;
a touchscreen;
a first processor to provide at least one telephone user interface image to said display and receive user input from corresponding locations on said touchscreen; and
a second processor to provide one or more user interface images to said display and receive user input from corresponding locations on said touchscreen, for use with tasks run by said second processor; and
a power source for powering said Electronic Device via said connector.

84. A device as in claim 83 wherein said first processor utilizes a first operating system, and said second processor utilizes a second operating system.

85. A device as in claim 83 which further comprises structure for:
creating image data defining an image of X pixels wide by Y pixels high;
displaying on said display a portion of said image equal to X pixels wide and Y/N pixels high; and
displaying on said monitor said image of X pixels wide by Y pixels high.

86. A device as in claim 85 where N equals two.

87. A device as in claim 83 which further comprises structure for:
displaying on said display a portion of said image equal to X1 pixels wide and Y1 pixels high; and
displaying on said monitor said image of X2 pixels wide by Y2 pixels high.

88. A device as in claim 83 wherein said docking station comprises a telephone connection, and means for operating said telephone connection concurrently with the operation of said telephone circuitry, achieving two concurrent telephone sessions.

89. A computer system as in claim 83 which further comprises one or more user input devices selected from the group consisting of keyboard, mouse, tablet, touchscreen, joystick, and speech recognition unit.

90. A computer system as in claim 83 wherein said docking station comprises a computer.

91. A computer system as in claim 83 wherein said computer uses said Electronic Device as a slave device.

92. A computer system as in claim 83 wherein said docking station includes audio interfaces for use by said Electronic Device while said Electronic Device is interfaced with said connector.

93. A computer system as in claim 92, further comprising voice command and control to operate one or more functions of said computer system via user voice command.

94. A system as in claim 80 wherein said voice command and control serves to control at least one function of said first processor and at least one function of said second processor.

95. A computer system as in claim 70 wherein said docking station comprises a network connection, allowing said Electronic Device to connect to said network.

96. A method for operating a computer system comprising a first display and a second display comprising the steps of:
creating image data defining an image of X pixels wide by Y pixels high;
displaying on said first display a portion of said image equal to X pixels wide and Y/N pixels high; and
displaying on said second display said image of X pixels wide by Y pixels high.

97. A method as in claim 96 wherein said first display is disabled when said second display is displaying image information.

98. A method for operating an electronic device comprising telephone circuitry, a display, a user input device, a first processor, and a second processor, comprising the steps of:
using said first processor as a system processor to control said telephone circuitry during telephone operation; and
awakening said second processor and utilizing said second processor to perform higher level computing tasks.

99. A method as in claim 98 which further comprises a step of utilizing said system processor for low level operational and computational tasks without awakening said second processor.

100. A method as in claim 99 wherein said display receives from said system processor display data associated with tasks performed by said system processor and said display receives from said second processor display data associated with tasks performed by said second processor.

101. A method as in claim 98 wherein said second processor retrieves its state information from disk upon awakening.

102. A method as in claim 98, wherein said first processor utilizes a first operating system and said second processor utilizes a second operating system.

103. A method as in claim 102 which further comprises the step of synchronizing data used by similar programs operating in said first and said second operating systems.
